(19) United States
(12) Patent Application Publication
(10) Pub. No.: US 2026/0153070 A1
(43) Pub. Date: Jun. 4, 2026

(54) WAVE POWER ENGINE

(71) Applicant: Daishi SHINDO, Shimotsuma-shi (JP)

(72) Inventor: Daishi SHINDO, Shimotsuma-shi (JP)

(21) Appl. No.: 19/457,154

(22) Filed: Jan. 23, 2026

Related U.S. Application Data
(63) Continuation of application No. PCT/JP2024/023689, filed on Jun. 29, 2024.

(30) Foreign Application Priority Data
Aug. 22, 2023 (JP) 2023-135050

(51) Int. Cl. F03B 13/16

(52) U.S. Cl. CPC F03B 13/16

(57) ABSTRACT

A wave power engine converts motion of a marine mobile unit into an energy, including: a first container portion fixedly mounted on a marine mobile unit and configured to move in accordance with the motion of the marine mobile unit; a weight portion housed inside the first container portion and configured to be movable in the first container portion so that the weight portion performs a relative motion with respect to the first container portion; a hydraulic pump configured to apply pressure to a fluid using kinetic energy based on the relative motion of the weight portion; and a hydraulic accumulator configured to accumulate the pressure of the fluid by sealing the fluid pressurized by the hydraulic pump, wherein the weight portion pushes a piston due to the relative motion so that the piston slides in a cylinder in the hydraulic pump and the pressure is applied to the fluid.

### CROSS-REFERENCE TO RELATED APPLICATIONS

This Application claims the benefit of priority and is a Continuation application of the prior International Patent Application No. PCT/JP2024/023689, with an international filing date of Jun. 29, 2024, which designated the United States, and is related to the Japanese Patent Application No. 2023-065625, filed Aug. 22, 2023, the entire disclosures of all applications are expressly incorporated by reference in their entirety herein.

### TECHNICAL FIELD

The present invention relates to a wave power engine that converts a motion of a marine mobile unit into a predetermined energy.

### BACKGROUND OF THE INVENTION

Conventionally, a wave power generation that generates an electric power using an energy of wave has been put into practical use. As a method of the wave power generation, a method that directly utilizes a fluid energy of wave is known. For example, a method of generating the electric power by driving a turbine with water flow, and a method of generating the electric power by converting a water flow into a swinging motion of a wave receiving member are known. In addition, as another method of the wave power generation, a method that utilizes actions caused by the wave is known. For example, a method of generating the electric power using kinetic energy of a floating structure that moves due to the wave motion is known.

Here, as a method of converting the water flow into the swinging motion of the wave receiving member to generate the electric power is disclosed. For example, Patent Document 1 discloses a technology including a wave receiving member that swings by receiving the wave force, and generating the electric power using a hydraulic motor that operates by hydraulic pressure generated based on the swinging motion of the wave receiving member.

In addition, as a method of generating the electric power using the kinetic energy of the floating structure that moves in accordance with the wave motion is disclosed. For example, Patent Document 2 discloses a technique of generating the electric power using the kinetic energy of a weight that is mounted inside a floating structure and moves in response to fluctuations of the water surface.

### PRIOR ART DOCUMENT

### Patent Documents

Patent Document 1: Japanese Patent Application Publication No. 2015-108344

Patent Document 2: Japanese Patent Application Publication No. 2012-215120

### SUMMARY OF THE INVENTION

### Problem to be Solved by the Invention

In the conventionally-known methods that directly utilize the fluid energy of the wave (e.g., in a method of generating the electric power by driving the turbine with the water flow), a power generation device can be configured relatively easily by installing a water channel and a turbine on a hull. However, these components tend to become movement resistance of the hull. In addition, in the technology described in Patent Document 1, since the wave receiving member directly receives the water flow and swings, durability performance of the wave receiving member tends to become problematic.

On the other hand, in a method of generating the electric power using the kinetic energy of the floating structure that moves due to the wave motion, since components of the power generation device do not directly receive water flow, there is little concern that the durability performance of the components becomes problematic due to the influence of the water flow. Here, according to the technology described in Patent Document 2, the electric power can be generated by driving the generator based on reciprocating linear motion of a weight that moves in response to the fluctuation of the water surface. In order to increase the amount of power generation, it is necessary to use a large generator or use multiple generators, and the cost of devices used for the wave power generation tends to become high. As described above, various problems still remain in the wave power generation that generates the electric power using the energy of the wave, and the technology for converting the energy of the wave and suitably storing the energy still leaves room for improvement.

An object of the present disclosure is to provide a technology for converting the energy of the wave and suitably storing the energy.

### Means for Solving the Problems

A wave power engine of the present disclosure is a wave power engine provided on a marine mobile unit configured to move on sea by self-propulsion or towing for converting a motion of the marine mobile unit into a predetermined energy. The wave power engine includes: a first container portion fixedly mounted on the marine mobile unit and configured to move in accordance with the motion of the marine mobile unit; a weight portion housed inside the first container portion and configured to be movable in the first container portion so that the weight portion performs a relative motion with respect to the first container portion; a pressurizing portion configured to apply a pressure to a predetermined fluid using a kinetic energy based on the relative motion of the weight portion; and an accumulator configured to accumulate the pressure of the predetermined fluid by sealing the predetermined fluid pressurized by the pressurizing portion, wherein the pressurizing portion is constituted by a hydraulic pump having a cylinder and a piston, and the piston slides in the cylinder of the hydraulic pump to apply the pressure to the predetermined fluid when the weight portion pushes the piston due to the relative motion.

The above described wave power engine is a device for converting the motion of the marine mobile unit into a predetermined energy. Here, the marine mobile unit is a mobile body configured to be movable at the sea by self-propulsion or towing. The marine mobile unit is, for example, a ship or a marine floating structure such as a mega-float. In the above described wave power engine, when the first container portion moves in accordance with the motion of the marine mobile unit caused by the wave, the weight portion moves relatively with respect to the first container portion and the pressurizing portion applies the pressure to a predetermined fluid using the kinetic energy of the weight portion. The above described predetermined fluid is, for example, a hydraulic oil usable in hydraulic devices such as a hydraulic motor. When the fluid pressurized by the pressurizing portion is introduced to the accumulator, the pressure of the fluid is accumulated. Because of this, a pressure energy of the fluid can be stored in the accumulator. Namely, according to the present disclosure, the kinetic energy of the weight portion that performs the relative motion with respect to the first container portion in association with the motion of the marine mobile unit caused by the wave can be suitably converted into the pressure energy of the fluid. Then, the pressure energy can be stored in the accumulator.

In the above wave power engine, the weight portion pushes the piston of the hydraulic pump due to the relative motion so that the pressure is applied to the fluid. Because of this, the energy of the wave can be suitably converted. In addition, in the wave power engine of the present disclosure, in the above described configuration, the weight portion may be constituted by a predetermined tank configured to be capable of sealing the fluid in the predetermined tank, and the accumulator may be provided in the weight portion by sealing the fluid pressurized by the pressurizing portion in the tank. Because of this, the weight of the tank, which is a configuration for accumulating the pressure of the fluid, and the weight of the fluid sealed in the tank can be utilized as the energy for pressurizing the fluid. Thus, cost reduction and space saving of devices used for utilizing the energy of the wave are achieved.

In addition, in the above described wave power engine, the pressurizing portion may be constituted by four hydraulic pumps, and each of the four hydraulic pumps may be installed at four corners of the first container portion formed in a rectangular parallelepiped shape, and the first container portion may be configured to include a first rail extending in a predetermined first direction and a second rail extending in a second direction orthogonal to the first direction. In this case, when the weight portion performs the relative motion in the first direction with respect to the first container portion due to the motion of the marine mobile unit, the piston may be pushed inward due to the relative motion in one of two pairs of hydraulic pumps facing each other in the first direction among the four hydraulic pumps and the piston may be pulled outward due to the relative motion in the other of the two pairs of hydraulic pumps. In addition, when the weight portion performs the relative motion in the second direction with respect to the first container portion due to the motion of the marine mobile unit, the piston may be pushed inward due to the relative motion in one of two pairs of hydraulic pumps facing each other in the second direction among the four hydraulic pumps and the piston may be pulled outward due to the relative motion in the other of the two pairs of hydraulic pumps.

Furthermore, in this case, at the four corners of the first container portion where the pressurizing portion is installed, a shaft portion that supports the pressurizing portion may be provided, and the pressurizing portion may be rotatably supported with respect to the shaft portion via an insertion hole formed at an end portion opposite to the piston of the cylinder so that the shaft portion is inserted into the insertion hole. Here, the weight portion may have a coupling configured to be connected with the piston, each of the four hydraulic pumps may have a biasing means for biasing the piston toward the coupling, and the coupling and the piston may abut in a non-fastened state in a state where the four hydraulic pumps are installed at the four corners of the first container portion so that the piston is configured to be slidable with respect to the coupling at an abutting surface.

The above described wave power engine may include a second container portion stacked vertically upward with respect to the first container portion. In this case, the wave power engine may further include a tube for supplying the fluid filled in the second container portion into the cylinder of each of the four hydraulic pumps or include a flow path for supplying the fluid filled in the second container portion to the first container portion.

### Effects of the Invention

According to the present disclosure, the energy of the wave can be converted and the energy can be suitably stored.

### BRIEF DESCRIPTION OF DRAWINGS

FIGS. 1A and 1B are diagrams showing a schematic configuration of a wave power engine in the first embodiment.

FIGS. 2A and 2B are diagrams for explaining an embodiment of converting the energy of the wave and storing the energy in the first embodiment.

FIGS. 3A to 3C are diagrams for explaining a structure of a hydraulic accumulator.

FIGS. 4A and 4B are diagrams showing a schematic configuration of a wave power engine in the second embodiment in comparison with the wave power engine of the first embodiment.

### DETAILED DESCRIPTION OF THE INVENTION

### 0017

Hereinafter, the embodiments of the present disclosure will be explained based on the drawings.

The configurations of the following embodiments are merely examples, and the present disclosure is not limited to the configurations of the embodiments.

### 0018

### <First Embodiment>

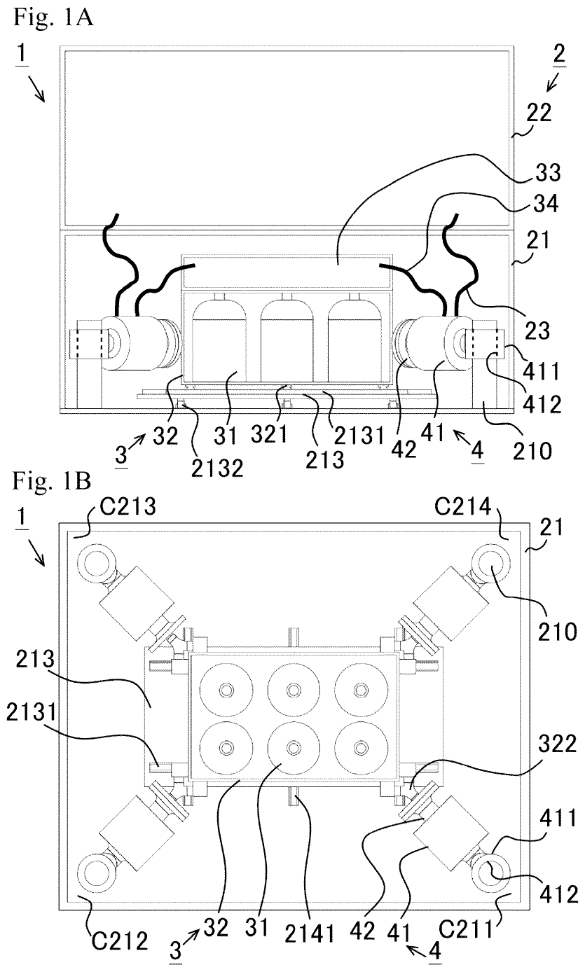

An overview of the wave power engine in the first embodiment will be explained with reference to FIGS. 1A and 1B.

FIGS. 1A and 1B are diagrams showing a schematic configuration of the wave power engine in the present embodiment.

A wave power engine 1 according to the present embodiment is a device for converting a motion (oscillation) of a marine mobile unit into a predetermined energy.

Here, the marine mobile unit is a mobile body configured to move on the sea by self-propulsion or towing. The marine mobile unit is, for example, a ship or a marine floating structure such as a mega-float.

The wave power engine 1 is realized by incorporating predetermined configurations into a container 2 as shown in FIGS. 1A and 1B.

A conventionally-known marine container can be used for the container 2. The container 2 in the present embodiment is a dry container (general-purpose container).

FIG. 1A is a front view of the wave power engine 1, and FIG. 1B is a plan view of the wave power engine 1. To illustrate the inside of the container 2, the illustration of one side surface of a first container portion 21 and a second container portion 22 is omitted in FIG. 1A, and the illustration of the second container portion 22 and the top surface of the first container portion 21 is omitted in FIG. 1B.

### 0019

As shown in FIGS. 1A and 1B, the wave power engine 1 includes: a first container portion 21 fixedly mounted on the marine mobile unit and configured to move (oscillate) in accordance with the motion of the marine mobile unit; a weight portion 3 housed inside the first container portion 21 and configured to be movable inside the first container portion 21; a hydraulic pump 4 (the pressurizing portion in the present disclosure) configured to apply a pressure to a predetermined fluid using a kinetic energy of the weight portion 3; and a hydraulic accumulator 31 (the accumulator in the present disclosure) configured to accumulate the pressure of the fluid by sealing the predetermined fluid pressurized by the hydraulic pump 4.

Here, the above described predetermined fluid in the present embodiment is a hydraulic oil usable in hydraulic devices such as a hydraulic motor.

However, there is no intention to limit to the fluid. The above described predetermined fluid may be, for example, a liquid such as water.

### 0020

In the present embodiment, the second container portion 22 is stacked vertically upward with respect to the first container portion 21.

The hydraulic oil is filled in an internal space of the second container portion 22, and a tube 23 for supplying the hydraulic oil filled in the second container portion 22 into a cylinder 41 of the hydraulic pump 4 is provided.

Because of this, the hydraulic oil filled in the second container portion 22 is supplied into the cylinder 41 of the hydraulic pump 4 via the tube 23.

### 0021

As shown in FIGS. 1A and 1B, the weight portion 3 is configured to include a hydraulic accumulator 31 and a housing 32 that is a casing surrounding the hydraulic accumulator 31.

In the present embodiment, a plurality of hydraulic accumulators 31 is housed in the housing 32.

Here, as described above, the hydraulic accumulator 31 is a tank that seals the hydraulic oil pressurized by the hydraulic pump 4.

Namely, in the present embodiment, the weight portion 3 is constituted by the hydraulic accumulators 31 configured to be capable of sealing the hydraulic oil in the hydraulic accumulators 31. Since the hydraulic oil pressurized by the hydraulic pump 4 is sealed in the hydraulic accumulators 31, the accumulator is provided in the weight portion.

Because of this, the weight of the hydraulic accumulator 31, which is a configuration for accumulating the pressure of the hydraulic oil, and the weight of the hydraulic oil sealed in the hydraulic accumulator 31 can be utilized as the energy for pressurizing the hydraulic oil. Thus, cost reduction and space saving of devices used for utilizing the energy of the wave are achieved.

### 0022

The above described weight portion 3 is configured to be movable inside the first container portion 21 and performs a relative motion with respect to the first container portion 21.

As shown in FIGS. 1A and 1B, in the present embodiment, the weight portion 3 is arranged on a first arrangement portion 213.

Here, the first arrangement portion 213 is configured to include a first rail 2131 extending in a predetermined first direction.

The above described first direction is, for example, a longitudinal direction of the first container portion 21.

In addition, the weight portion 3 has a first moving member 321 that is fixed at a position facing the first rail 2131 in a state where the weight portion 3 is housed in the first container portion 21. The first moving member 321 is configured to be horizontally movable along the first rail 2131.

The first moving member 321 is a roller fixed to a bottom surface of the housing 32. When the above described first moving member 321 is slid on the first rail 2131 due to the motion of the marine mobile unit, the weight portion 3 performs the relative motion with respect to the first container portion 21.

### 0023

Furthermore, in the present embodiment, as shown in FIGS. 1A and 1B, a second rail 2141 extending in a second direction orthogonal to the above described first direction is provided on a bottom surface of inside the first container portion 21.

The first arrangement portion 213 is configured to include a second moving member 2132 that is fixed at a position facing the second rail 2141 and is configured to be horizontally movable along the second rail 2141.

The second moving member 2132 is a roller fixed to the first arrangement portion 213. When the above described second moving member 2132 is slid on the second rail 2141 due to the motion of the marine mobile unit, the weight portion 3 performs the relative motion with respect to the first container portion 21.

According to the above described configuration, due to the motion of the marine mobile unit, the weight portion 3 performs the relative motion with respect to the first container portion 21 by the first moving member 321 fixed to the weight portion 3 (the bottom surface of the housing 32) sliding on the first rail 2131 of the first arrangement portion 213, and/or by the second moving member 2132 fixed to the first arrangement portion 213 on which the weight portion 3 is arranged sliding on the second rail 2141.

### 0024

A filling portion 33 is formed on the housing 32 for introducing the hydraulic oil to be sealed in the hydraulic accumulators 31 is temporarily enclosed in the filling portion 33. The hydraulic oil introduced from the hydraulic pump 4 is introduced into the hydraulic accumulators 31 via the filling portion 33.

The hydraulic pump 4 and the filling portion 33 are connected by a tube 34.

### 0025

In addition, the hydraulic pump 4 is a conventionally-known piston pump having a cylinder 41 and a piston 42. In the present embodiment, the above described hydraulic pumps 4 are installed at four corners (C211 to C214 in FIG. 1B) of the first container portion 21.

Due to the relative motion of the weight portion 3 with respect to the first container portion 21, the weight portion 3 pushes the piston 42 so that the piston 42 slides in the cylinder 41 and the pressure is applied to the hydraulic oil.

Here, a shaft portion 210 that supports the hydraulic pump 4 is provided at each of the four corners (C211 to C214 in FIG. 1B) of the first container portion 21.

The hydraulic pump 4 is rotatably supported with respect to the shaft portion 210 via an insertion hole 412 formed at an end portion 411 opposite to the piston 42 of the cylinder 41 so that the shaft portion 210 is inserted the insertion hole 412.

The piston 42 is connected to the weight portion 3 via a coupling 322 fixed to a side surface of the housing 32.

### 0026

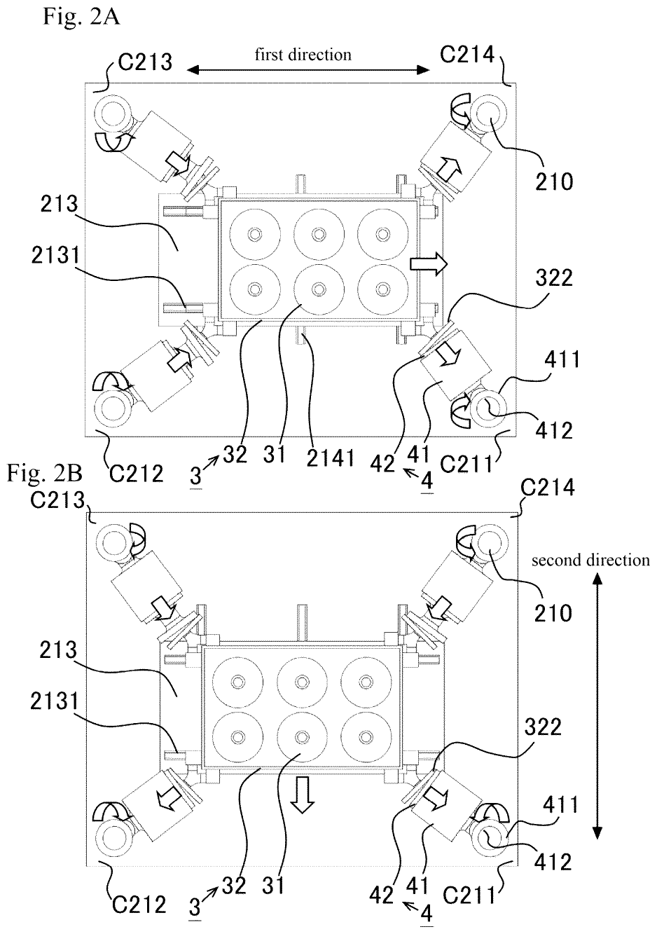

Next, the embodiment of converting the energy of the wave and storing the energy (i.e., the embodiment of accumulating the kinetic energy generated due to the motion of the marine mobile unit caused by the wave as a pressure of the hydraulic oil) will be explained based on FIGS. 2A and 2B.

FIGS. 2A and 2B are diagrams for explaining an embodiment of converting the energy of the wave and storing the energy in the present embodiment.

FIG. 2A shows a case where the first container portion 21 also moves in accordance with the motion of the marine mobile unit caused by the wave, and the weight portion 3 performs the relative motion in the first direction with respect to the first container portion 21. FIG. 2B shows a case where the first container portion 21 also moves in accordance with the motion of the marine mobile unit caused by the wave, and the weight portion 3 performs the relative motion in the second direction with respect to the first container portion 21.

### 0027

Regarding two pairs of hydraulic pumps facing each other in the first direction among the four hydraulic pumps 4, as shown in FIG. 2A, when the weight portion 3 performs the relative motion in the first direction with respect to the first container portion 21 due to the motion of the marine mobile unit, the piston 42 is pushed inward due to the relative motion in the first pair, which is one pair of two pairs of the hydraulic pumps 4 (the hydraulic pumps 4 arranged at C211 and C214), and the piston 42 is pulled outward due to the relative motion in the second pair, which is the other of the two pairs of the hydraulic pumps 4 (the hydraulic pumps 4 arranged at C212 and C213).

### 0028

At this time, the hydraulic pump 4 rotates with respect to the shaft portion 210 due to the movement of the weight portion 3.

Here, as described above, in the hydraulic pump 4, the insertion hole 412 is formed at the end portion 411 opposite to the piston 42 of the cylinder 41, and the insertion hole 412 and the shaft portion 210 are connected via a rolling bearing.

Therefore, when the coupling 322 fixed to the side surface of the housing 32 presses the piston 42 of the hydraulic pump 4 arranged at C211 due to the movement of the weight portion 3, the hydraulic pump 4 rotates toward the C214 while the piston 42 is pushed inward.

Similarly, the hydraulic pump 4 arranged at C214 rotates toward the C211 while the piston 42 is pushed inward.

Here, in a state where each of the hydraulic pumps 4 is installed at the four corners of the first container portion 21, the coupling 322 and the piston 42 abut in a non-fastened state. Thus, the piston 42 is configured to be slidable with respect to the coupling 322 at the abutting surface.

Because of this, in the hydraulic pump 4, the piston 42 can be slid with respect to the cylinder 41 and the hydraulic pump 4 itself can be rotated.

Note that a lubricant such as silicone may be applied to each of the abutting surfaces between the coupling 322 and the piston 42.

### 0029

On the other hand, at this time, in the hydraulic pumps 4 arranged at C212 and C213, the piston 42 is pulled outward due to the movement of the weight portion 3.

Here, the hydraulic pump 4 has a spring that biases the piston 42 in a direction to pull the piston 4 outward. When the weight portion 3 moves as described above, the spring biases the piston 42 toward the coupling 322.

Therefore, the hydraulic pump 4 arranged at C212 rotates toward the C211 while the piston 42 is pulled outward, and the hydraulic pump 4 arranged at C213 rotates toward the C214 while the piston 42 is pulled outward.

### 0030

Furthermore, regarding two pairs of hydraulic pumps facing each other in the second direction among the four hydraulic pumps 4, as shown in FIG. 2B, when the weight portion 3 performs the relative motion in the second direction with respect to the first container portion 21 due to the motion of the marine mobile unit, the piston 42 is pushed inward due to the relative motion in the third pair, which is one pair of two pairs of the hydraulic pumps 4 (the hydraulic pumps 4 arranged at C211 and C212), and the piston 42 is pulled outward due to the relative motion in the fourth pair, which is the other of the two pairs of the hydraulic pumps 4 (the hydraulic pumps 4 arranged at C213 and C214).

### 0031

Specifically, the hydraulic pump 4 arranged at C211 rotates toward the C212 while the piston 42 is pushed inward, and the hydraulic pump 4 arranged at C212 rotates toward the C211 while the piston 42 is pushed inward.

On the other hand, the hydraulic pump 4 arranged at C213 rotates toward the C212 while the piston 42 is pulled outward, and the hydraulic pump 4 arranged at C214 rotates toward the C211 while the piston 42 is pulled outward.

### 0032

As described above, when the first container portion 21 also moves in accordance with the motion of the marine mobile unit caused by the wave and the weight portion 3 performs the relative motion in the first direction with respect to the first container portion 21, the piston 42 is pushed inside due to the relative motion in the first pair of hydraulic pumps 4 arranged at C211 and C214 and in the third pair of hydraulic pumps 4 arranged at C211 and C212, for example.

Therefore, the pressure can be applied to the hydraulic oil using the kinetic energy based on the relative motion of the weight portion 3. Thus, the kinetic energy of the weight portion 3 that performs the relative motion with respect to the first container portion 21 due to the motion of the marine mobile unit caused by the wave can be suitably converted into the pressure energy of the hydraulic oil.

### 0033

Here, the hydraulic oil pressurized by the hydraulic pump 4 is introduced to the filling portion 33 via the tube 34.

Note that a check valve is provided at a connection portion between the cylinder 41 and the tube 34 to restrict the flow of the hydraulic oil flowing through the tube 34 to one direction from the cylinder 41 to the filling portion 33.

Thus, the hydraulic oil from the hydraulic pump 4 is introduced to the hydraulic accumulator 31 via the filling portion 33.

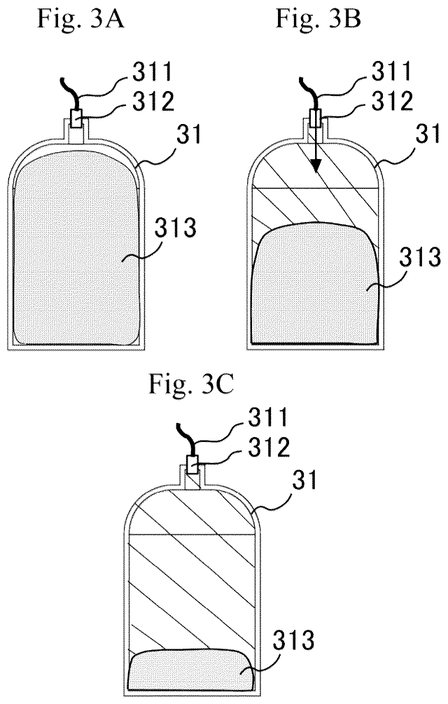

This will be explained based on FIGS. 3A to 3C.

FIGS. 3A to 3C are diagrams for explaining the structure of the hydraulic accumulator 31.

As shown in FIG. 3A, in a state where the hydraulic oil is not supplied into the hydraulic accumulator 31, a gas bag 313 filled with a gas such as nitrogen occupies the inside of the hydraulic accumulator 31.

When the hydraulic oil from the filling portion 33 is introduced to the hydraulic accumulator 31 via a tube 311, the hydraulic oil is filled so as to compress the gas bag 313 as shown in FIG. 3B.

Here, a check valve 312 is provided at a connection portion between the tube 311 and the hydraulic accumulator 31. Thus, even in a state where the filling of the hydraulic oil into the hydraulic accumulator 31 is completed as shown in FIG. 3C, a backflow of the hydraulic oil to the tube 311 is prevented.

Because of this, the pressure energy of the hydraulic oil can be accumulated in the hydraulic accumulator 31.

### 0034

On the other hand, when the weight portion 3 performs the relative motion in the first direction with respect to the first container portion 21, the piston 42 is pulled outward due to the relative motion in the second pair of hydraulic pumps 4 arranged at C212 and C213 and in the fourth pair of hydraulic pumps 4 arranged at C213 and C214, for example.

Therefore, the volume inside the cylinder 41 increases, and the hydraulic oil filled in the second container portion 22 is supplied into the cylinder 41 of the hydraulic pump 4 via the tube 23.

Note that a check valve is provided at a connection portion between the cylinder 41 and the tube 23 to restrict the flow of the hydraulic oil flowing through the tube 23 to one direction from the second container portion 22 to the cylinder 41.

### 0035

In the above explanation, an example of stacking the second container portion 22 vertically upward with respect to the first container portion 21 is described. However, the first container portion 21 and the second container portion 22 may be arranged spaced apart from each other.

In this case, the first container portion 21 including the weight portion 3 may be arranged at a bottom portion of the marine mobile unit, for example.

Therefore, the first container portion 21, which has a relatively large weight, serves as ballast, and a center of gravity of the marine mobile unit can be lowered.

At this time, the second container portion 22 may be arranged at any location. As described above, the hydraulic oil filled in the second container portion 22 may be supplied into the cylinder 41 of the hydraulic pump 4 via the tube 23.

### 0036

According to the wave power engine 1 described above, the kinetic energy of the weight portion 3 that performs the relative motion with respect to the first container portion 21 due to the motion of the marine mobile unit caused by the wave can be suitably converted into the pressure energy of the hydraulic oil.

Then, the pressure energy can be stored in the hydraulic accumulator 31.

Namely, according to the present disclosure, the energy of the wave can be converted and the energy can be suitably stored.

### 0037

Here, in the present embodiment, the electric power may be generated using the pressure energy stored in the hydraulic accumulator 31.

For example, the hydraulic oil stored in the hydraulic accumulator 31 may be supplied to a conventionally-known hydraulic motor to output a shaft output, and the shaft output may be input to a conventionally-known generator to generate the electric power.

In addition, a hydraulic machinery may be driven using the pressure energy stored in the hydraulic accumulator 31.

When high-pressure hydraulic oil stored in the hydraulic accumulator 31 is used as a drive source for a machinery, large output can be extracted from the machinery at a relatively high speed.

### 0038

When the above described wave power engine is installed on a marine floating structure such as a mega-float, an offshore resource factory can be realized.

Since seawater contains sodium chloride and magnesium chloride, hydrochloric acid and magnesium can be produced by electrolyzing the seawater.

Therefore, the electric power is generated using the energy from the wave power engine, and the hydrochloric acid and the magnesium are produced by electrolyzing the seawater with the electric power.

When the produced hydrochloric acid and magnesium are transported to land, the hydrochloric acid and the magnesium can be used as fuel for fuel cells and gas engines.

For example, according to a gas engine system using the hydrochloric acid and the magnesium as fuel, hydrogen can be generated by injecting granulated magnesium into the hydrochloric acid, and a gas engine can be driven by combusting the hydrogen.

The above described gas engine system can be used, for example, as a range extender for an electric vehicle.

In a gas engine system using the hydrochloric acid and the magnesium as fuel, relatively low output tends to be continuously extracted. Thus, the electric power is generated with a generator using the output and a battery is charged with the electric power to extend the cruising range of the electric vehicle.

When a production device of the above described hydrochloric acid and magnesium is further mounted on a ship on which the wave power engine is installed, the produced hydrochloric acid and magnesium can also be used as fuel for a power source of the ship.

### 0039

Furthermore, in the above described factory, a seawater desalination device may be operated using the energy from the wave power engine.

Here, when a reverse osmosis membrane method is used for the seawater desalination device, high pressure may be applied to the seawater using the pressure of the fluid accumulated in the accumulator of the wave power engine (e.g., by driving the piston with the pressure), and only pure water in the seawater can be passed through a permeable membrane to obtain fresh water.

In this case, since the seawater desalination device is operated using the pressure energy converted from the energy of the wave, the desalination device can be operated semi-permanently.

Similarly, a filtration device that filters pollutants contained in the seawater may be operated using the energy from the wave power engine.

### 0040

In addition, when the above-described wave power engine is installed on a floating breakwater, a breakwater capable of converting the energy of the wave and storing the energy may be realized.

According to the above described floating breakwater, wave protection near seawalls where the wave is rough can be achieved and much energy can be stored from rough wave.

### 0041

In addition, the accumulator of the wave power engine may be transported to land, and a land-based resource factory may be realized using the pressure of the fluid accumulated in the accumulator.

In the above described resource factory, for example, bio-coke and ammonia are produced.

When producing the bio-coke, plants as raw materials need to be placed under high temperature and high pressure. By using high pressure from the pressure of the fluid accumulated in the above described accumulator and high temperature that can be realized by the electric power generated using the pressure of the fluid accumulated in the above described accumulator, zero-emission fuel can be produced from renewable energy.

In addition, when producing ammonia, nitrogen and hydrogen need to be reacted with an iron oxide catalyst at high temperature and high pressure. Since high temperature and high pressure can be obtained from the accumulator of the wave power engine in the same manner as described above, the ammonia can be produced from renewable energy.

The ammonia produced in the above described manner can be used, for example, as fuel for gas turbines and fuel cells.

### 0042

In addition, by installing the above-described wave power engine on a marine floating structure such as a mega-float and further installing a plurality of computers connected to a network on the marine floating structure, an offshore information processing facility can be realized.

In the above described information processing facility, the electric power is generated using the energy from the wave power engine and the computers can be operated with the generated electric power.

In the above described information processing facility, cryptocurrency mining may be performed, for example.

### 0043

### <Second Embodiment>

In the above described first embodiment, an example in which the hydraulic oil filled in the second container portion 22 is supplied into the cylinder 41 of the hydraulic pump 4 via the tube 23 is explained.

In contrast, in the present embodiment, the hydraulic oil filled in the second container portion 22 is first supplied to the first container portion 21.

Then, the hydraulic oil in the first container portion 21 in a liquid-tight state is supplied into the cylinder 41 of the hydraulic pump 4.

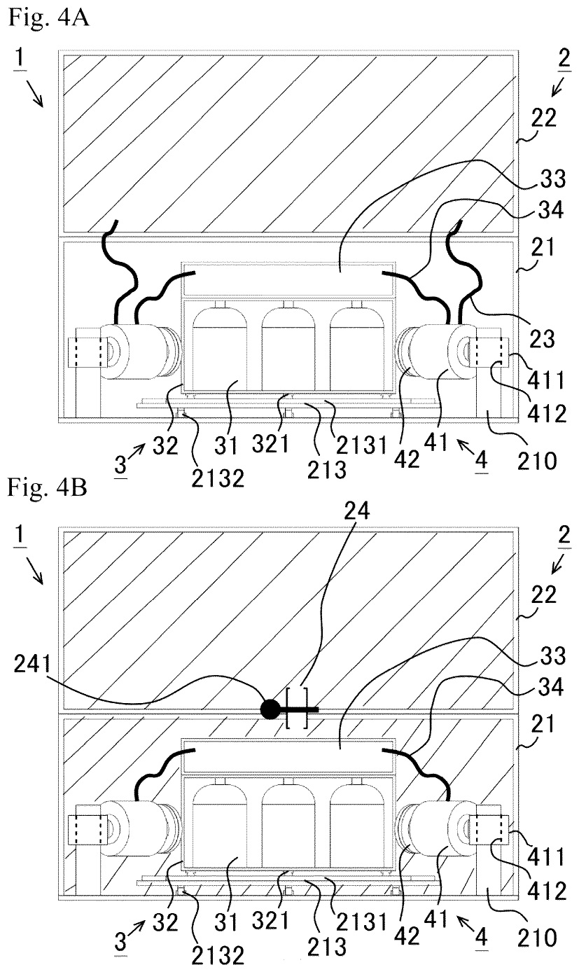

This will be explained based on FIGS. 4A and 4B.

### 0044

FIGS. 4A and 4B are diagrams showing a schematic configuration of the wave power engine in the present embodiment in comparison with the wave power engine of the first embodiment.

Here, the hydraulic oil is represented by hatching in FIGS. 4A and 4B.

### 0045

As shown in FIG. 4A, in the wave power engine 1 according to the first embodiment, the hydraulic oil filled in the second container portion 22 is supplied into the cylinder 41 of the hydraulic pump 4 via the tube 23.

In contrast, in the wave power engine 1 according to the present embodiment, as shown in FIG. 4B, a flow path 24 for supplying the hydraulic oil filled in the second container portion 22 to the first container portion 21 is provided, and the hydraulic oil filled in the second container portion 22 is supplied to the first container portion 21 via the flow path 24 by the gravity.

Therefore, an internal space of the first container portion 21 can be a liquid chamber maintained in a liquid-tight state with the hydraulic oil.

### 0046

When the internal space of the first container portion 21 is in a liquid-tight state with the hydraulic oil, the hydraulic oil around the cylinder 41 is supplied into the cylinder via a supply hole formed in the cylinder 41, for example.

### 0047

When the hydraulic oil is introduced from the hydraulic pump 4 to the hydraulic accumulator 31, the hydraulic oil in the first container portion 21 decreases.

Therefore, in the present embodiment, opening and closing of a solenoid valve 241 is controlled so that the inside of the first container portion 21 can be maintained in a liquid-tight state with the hydraulic oil.

### 0048

### <Other Embodiments>

The above described embodiments are merely examples, and the present disclosure can be appropriately modified and implemented within a scope not departing from the gist of the present disclosure.

For example, processes and means described in the present disclosure can be freely combined and implemented as long as technical contradictions do not arise.

### DESCRIPTION OF THE REFERENCE NUMERALS

1: wave power engine
2: container
21: first container portion
22: second container portion
3: weight portion
31: hydraulic accumulator
32: housing
4: hydraulic pump
41: cylinder
42: piston

1. A wave power engine provided on a marine mobile unit configured to move on sea by self-propulsion or towing for converting a motion of the marine mobile unit into a predetermined energy, the wave power engine comprising:
a first container portion fixedly mounted on the marine mobile unit and configured to move in accordance with the motion of the marine mobile unit;
a weight portion housed inside the first container portion and configured to be movable in the first container portion so that the weight portion performs a relative motion with respect to the first container portion;
a pressurizing portion configured to apply a pressure to a predetermined fluid using a kinetic energy based on the relative motion of the weight portion; and
an accumulator configured to accumulate the pressure of the predetermined fluid by sealing the predetermined fluid pressurized by the pressurizing portion, wherein
the pressurizing portion is constituted by four hydraulic pumps having a cylinder and a piston,
when the weight portion pushes the piston due to the relative motion, the piston slides in the cylinder of the four hydraulic pumps to apply the pressure to the predetermined fluid,
the four hydraulic pumps are installed at four corners of the first container portion formed in a rectangular parallelepiped shape,
the first container portion includes a first rail extending in a predetermined first direction and a second rail extending in a second direction orthogonal to the predetermined first direction,
when the weight portion performs the relative motion in the predetermined first direction with respect to the first container portion due to the motion of the marine mobile unit, the piston is pushed inward due to the relative motion in one of two pairs of hydraulic pumps facing each other in the predetermined first direction among the four hydraulic pumps and the piston is pulled outward due to the relative motion in the other of the two pairs of hydraulic pumps, and
when the weight portion performs the relative motion in the second direction with respect to the first container portion due to the motion of the marine mobile unit, the piston is pushed inward due to the relative motion in one of two pairs of hydraulic pumps facing each other in the second direction among the four hydraulic pumps and the piston is pulled outward due to the relative motion in the other of the two pairs of hydraulic pumps.

2. The wave power engine according to claim 1, wherein
at the four corners of the first container portion where the pressurizing portion is installed, a shaft portion that supports the pressurizing portion is provided, and
the pressurizing portion is rotatably supported with respect to the shaft portion via an insertion hole formed at an end portion opposite to the piston of the cylinder so that the shaft portion is inserted into the insertion hole.

3. The wave power engine according to claim 2, wherein
the weight portion has a coupling configured to be connected with the piston,
each of the four hydraulic pumps has a biasing means for biasing the piston toward the coupling, and
in a state where the four hydraulic pumps are installed at the four corners of the first container portion, the coupling and the piston abut in a non-fastened state so that the piston is configured to be slidable with respect to the coupling at an abutting surface.

4. The wave power engine according to claim 1, further comprising:
a second container portion stacked vertically upward with respect to the first container portion; and
a tube for supplying the fluid filled in the second container portion into the cylinder of each of the four hydraulic pumps.

5. The wave power engine according to claim 1, further comprising:
a second container portion stacked vertically upward with respect to the first container portion; and
a flow path for supplying the fluid filled in the second container portion to the first container portion.
